(19) United States
(12) Patent Application Publication
(10) Pub. No.: US 2016/0321655 A1
(43) Pub. Date: Nov. 3, 2016

(54) FUEL DISPENSING ENVIRONMENT HAVING ON-DEMAND REMOTE SUPPORT

(71) Applicant: Gilbarco Inc., Greensboro, NC (US)

(72) Inventors: Francis C. Williams, JR., Jamestown, NC (US); James E. Kelly, JR., Jamestown, NC (US); Andrew R. Pearce, Raleigh, NC (US); Michael J. Symonds, Greensboro, NC (US)

(21) Appl. No.: 15/143,614

(22) Filed: May 1, 2016

Related U.S. Application Data
(60) Provisional application No. 62/156,181, filed on May 1, 2015.

(51) Int. Cl. G06Q 20/38; G06Q 20/20; G06Q 20/40; G06Q 50/06; G07F 13/02; G05B 15/02

(52) U.S. Cl. CPC G06Q 20/3821; G07F 13/02; G05B 15/02; G06Q 20/401; G06Q 50/06; G06Q 20/204

(57) ABSTRACT

An electronic apparatus for use in a retail fueling environment comprises a processor and associated memory, as well as a display. A communication portal operative to communicate with a remote support service when desired is also provided. The processor implements software allowing access to the electronic apparatus by the remote support service only when the remote support service presents a substantially random credential generated on as needed basis at the electronic apparatus. For example, credential may be a password shown on the display of the electronic apparatus.

### PRIORITY CLAIM

This application relies upon and claims the benefit of provisional application Ser. No. 62/156,181, filed May 1, 2015, which is incorporated fully herein by reference for all purposes.

### FIELD OF THE INVENTION

The present invention relates generally to service stations at which fuel is dispensed. More particularly, the present invention relates to remote support of equipment utilized to process and record transactions at the service station.

### BACKGROUND

Retail fueling environments usually include a plurality of fuel dispensers located in a forecourt area outside of a convenience store building. Typically, the fuel dispensers will each be equipped with pay-at-the-pump capability by which the customer can perform the fueling transaction using a user interface on the respective fuel dispenser. For example, the customer can present a credit or debit card using a card reader installed on the fuel dispenser's user interface to pay for the fuel without entering the store. In other cases, the customer may want or need to go into convenience store to pay for the fuel or to purchase other items.

The convenience store will generally be equipped with a point-of-sale (POS) system to handle certain functions relating to transactions that occur in the retail fueling environment. For instance, the POS device may include software components adapted to display a graphical user interface (GUI). Transactions are recorded using the POS for inventory reconciliation and other recordkeeping purposes. In addition, the POS may allow the station's manager the ability to set options associated with the POS or the service station, such as the appearance of receipts issued by the station's dispensers.

Occasionally, service station operators may require expert assistance in the configuration or use of the POS system. Such assistance may be provided, for example, by a “Help Desk” at a call center established by the POS device's manufacturer. According to current practice, the service station operator will phone the Help Desk and describe the problem. In many cases, the Help Desk agent will be able to resolve the issue through issuance of verbal instructions to the service station operator. In more complicated cases, it might be necessary to grant the Help Desk operator remote access into the POS. This is done by enabling a modem (or direct network connection), by which the Help Desk operator attempts to establish a communication link with the POS system. In order for the link to be established, the Help Desk request must present an expected password to the POS device.

Currently, the password that is presented is the same password at all sites, across the machines. Once the modem (or network connection) is enabled, the Help Desk agent can dial into the site using the expected password, get connected and use a remote control guest function to remotely control manager workstation or cashier workstation terminals of the POS.

### SUMMARY OF CERTAIN ASPECTS

The present invention recognizes and addresses the foregoing considerations, and others, of prior art construction and methods. In this regard, certain exemplary and nonlimiting aspects of the present invention will now be described. These aspects are intended to provide some context for certain principles associated with the present invention, but are not intended to be defining of the full scope of the present invention.

Certain aspects of the present invention are directed to an electronic apparatus for use in a retail fueling environment. The apparatus comprises a processor and associated memory, as well as a display. A communication portal is operative to communicate with a remote support service when desired. The processor implements software allowing access to the electronic apparatus by the remote support service only when the remote support service presents a substantially random credential generated on as needed basis at the electronic apparatus. For example, the credential may be a password shown on the display of the fueling environment's electronic apparatus.

In an exemplary embodiment, the password may be an alphanumeric password or an alphanumeric password with symbols. Preferably, the software will be capable of simultaneously displaying a phonetic phrase corresponding to the password along with the password itself.

The electronic apparatus may comprise a point-of-sale (POS) system utilized in the retail fueling environment. The POS system may include a manager workstation and at least one cashier workstation.

Different systems and methods of the present invention utilize various combinations of the disclosed elements and method steps as supported by the overall disclosure herein. Thus, combinations of elements other than those discussed above may be claimed. Moreover, the accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a diagrammatic representation of a retail fueling environment incorporating certain aspects of the present invention.

FIG. 2 is a diagrammatic representation showing additional details of the enhanced dispenser hub of FIG. 1.

FIG. 3 is a diagrammatic representation showing additional details of a fuel dispenser shown in FIG. 1.

FIG. 4 is a flow chart showing exemplary methodology that may be used on the POS system of FIG. 1 in accordance with the present invention.

FIGS. 5 through 9 are exemplary screen shots that may appear during use of the POS system of FIG. 1 in accordance with the present invention.

FIG. 10 is a diagrammatic representation of a POS system in accordance with an alternative embodiment of the present invention.

FIG. 11 is a flow chart showing exemplary methodology that may be used on the POS system of FIG. 10 in accordance with the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

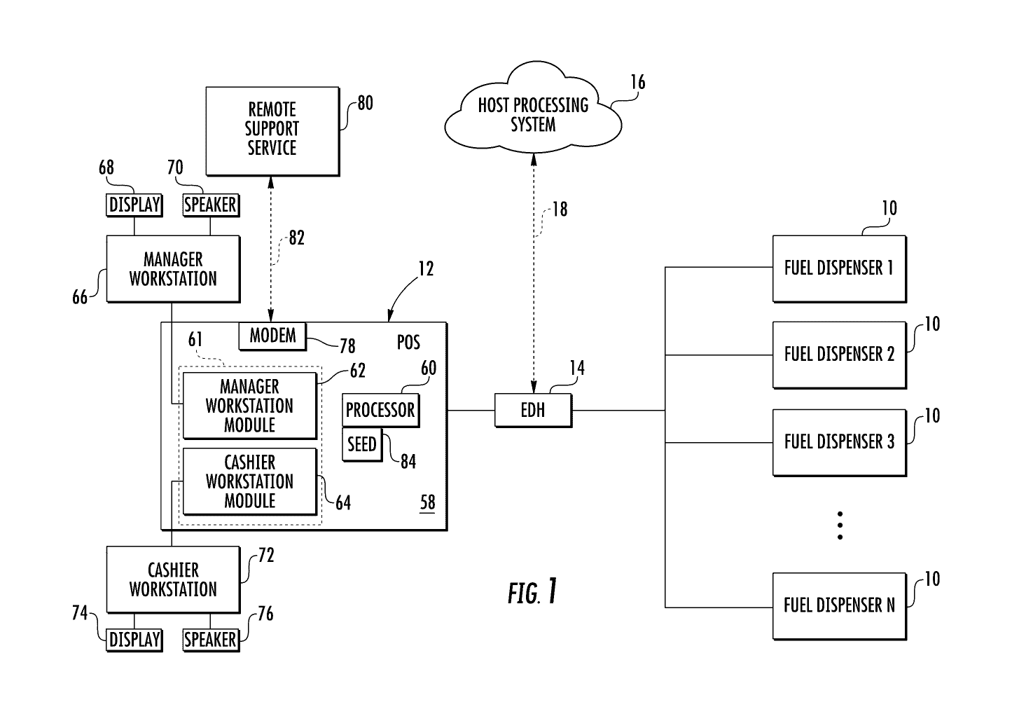

FIG. 1 illustrates an exemplary retail fueling environment in accordance with an embodiment of the present invention. One or more fuel dispensers 10 are located in the forecourt region of the retail fueling environment. The fuel dispensers are operative to dispense fuel supplied from one or more underground storage tanks (USTs) into a customer's vehicle. Typically, the fuel dispensers will be provided with “pay-at-the-pump” capability, allowing the customer to authorize and pay for the fueling transaction at the dispenser itself. The retail fueling environment also includes a point-of-sale (POS) system 12 that handles in-store sales activities, as well as various inventory and configuration functions.

Although embodiments are contemplated in which the electronic payment server is incorporated into or is in direct communication with POS 12, the illustrated embodiment utilizes an enhanced dispenser hub (EDH) 14 as shown and described in U.S. Pat. No. 8,438,064 (incorporated fully herein by reference for all purposes). EDH 14 includes an electronic payment server that allows processing of payment card information. In particular, credit (or debit) card information from the fuel dispensers 10 and any in-store card readers is fed to EDH 14, which seeks approval from a remote host processing system 16 via a suitable off-site communication link 18.

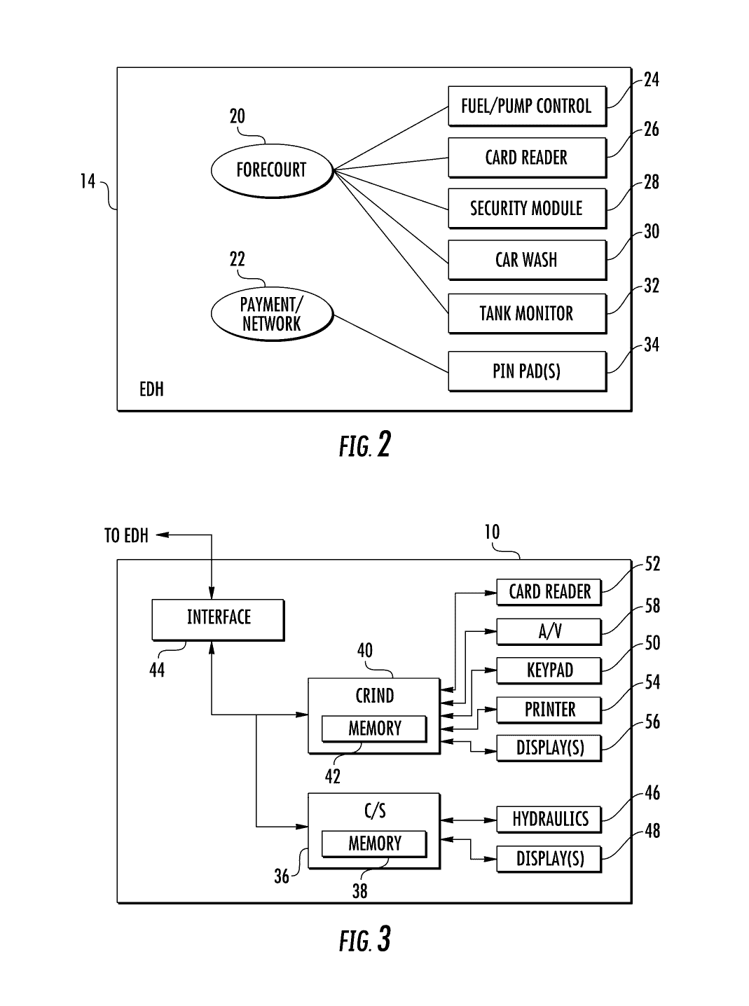

Referring now to FIG. 2, EDH 14 includes one or more processors and associated memory running a forecourt module 20 and a payment module 22. Forecourt module 20 is adapted to control the operation of devices located in the retail fueling environment's forecourt. In this example, forecourt module 20 comprises several modules, including fuel/pump control module 24, card reader module 26, security module 28, car wash module 30, and tank monitor module 32. The fuel/pump control module 24 handles operation of dispensers 10, while the car wash module 30 handles operation of any on-site car washes. The tank monitor module 32 handles operation of any tank monitors connected to the underground storage tanks of the retail fueling environment. The card reader module 26 handles operation of the card readers of the retail fueling environment, such as the card readers of dispensers 10. The security module 28 handles encryption of the sensitive information transmitted by the components of retail fueling environment. For instance, payment card data received by the various card readers in the retail fueling environment may be handled by the card reader module 26 and encrypted by the security module 28.

Payment module 22 performs validation of the payment card information received by the various card readers in the retail fueling environment. In particular, payment module 22 handles communications to and from the host processing system 16. As shown, payment module 22 communicates with a PIN pad module 34 when information from a PIN pad is necessary to process the transaction.

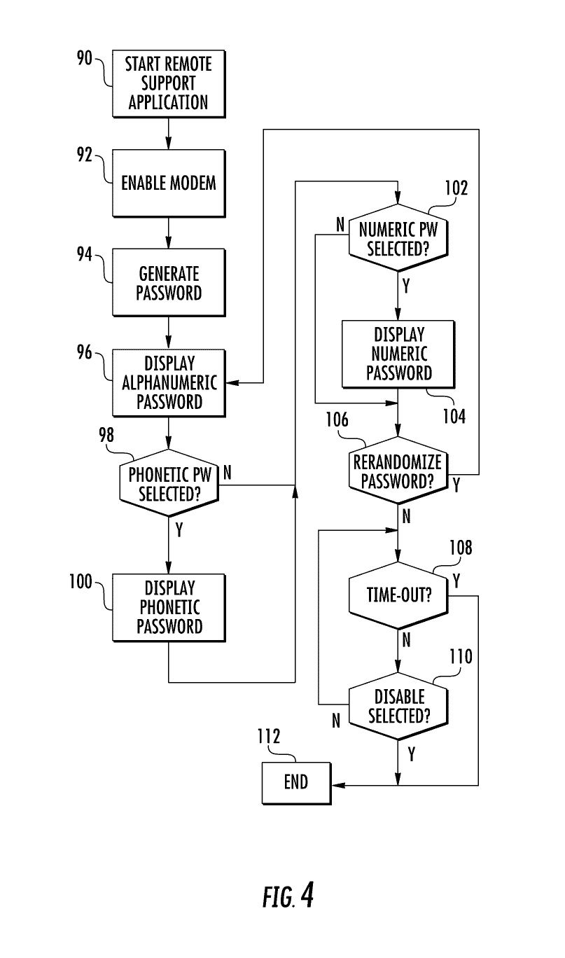

Referring now to FIG. 3, additional details regarding the various components of fuel dispenser 10 can be more easily explained. As shown, fuel dispenser 10 includes a control system 36 having an associated memory 38. In addition, dispenser 10 may also comprise a CRIND (card reader in dispenser) module 40 and associated memory 42. Those of ordinary skill in the art are familiar with CRIND units used in fuel dispensers, but additional background information is provided in U.S. Pat. No. 4,967,366, the entirety of which is incorporated by reference herein for all purposes.

As shown, control system 36 and CRIND module 40 are in operative communication with EDH 14 via an interface 44. In addition, although not specifically shown in FIG. 3, either or both of control system 36 and CRIND module 40 may be in wired or wireless communication with the Internet and/or one or more cloud servers via off-site communication link 18 (FIG. 1) or another suitable communication link.

Control system 36 includes the hardware and software necessary to control the hydraulic components and functions of dispenser 10. Those of ordinary skill in the art are familiar with the operation of the hydraulics 46 of dispenser 10. In general, however, fuel from USTs is pumped through a piping network into an inlet pipe. Fuel being dispensed passes though a flow meter, which is responsive to flow rate or volume. A displacement sensor, such as a pulser, is employed to generate a signal in response to fuel flow though the meter and communicate this information to control system 36. Control system 36 may also provide control signaling to a valve that may be opened and closed to permit or not permit dispensing of fuel.

Meter flow measurements from the displacement sensor are collected by control system 36. Control system 36 also typically performs calculations such as cost associated with a fuel dispensing transaction. As a dispensing transaction progresses, fuel is then delivered to a hose and through a nozzle into the customer's vehicle. Dispenser 10 includes a nozzle boot, which may be used to hold and retain the nozzle when not in use. The nozzle boot may include a mechanical or electronic switch in communication with control system 36 to indicate when the nozzle has been removed for a fuel dispensing request and when the nozzle has been replaced, signifying the end of a fueling transaction. Control system 36 may thus determine whether a transaction has been initiated or completed.

Control system 36 may further be operative to control one or more displays 48. For example, a transaction price total display may present customers with the price for fuel that is dispensed. A transaction gallon total display may be used to present customers with the measurement of fuel dispensed in units of gallons (or liters). Finally, price per unit (PPU) displays may be provided to show the price per unit of fuel dispensed in either gallons or liters, depending on the programming of dispenser 10.

CRIND module 40 includes the hardware and software necessary to support payment processing and peripheral interfaces at dispenser 10. In this regard, CRIND module 40 may be in operative communication with several input devices. For example, a PIN pad 50 is typically used for entry of a PIN if the customer is using a debit card for payment of fuel or other goods or services. CRIND module 40 may also be in operative communication with a card reader 52 for accepting credit, debit, or other magnetic stripe cards (or chip cards) for payment. Additionally, card reader 52 may accept loyalty or program-specific cards as is well known. Further, CRIND module 40 may be in operative communication with other payment or transactional devices such as a receipt printer 54.

One or more display(s) 56 may be used to display information, such as transaction-related prompts and advertising, to the customer. The customer may use soft keys to respond to information requests presented to the user via a display 56. In some embodiments, however, a touch screen may be used for display 56. In this case, display 56 may be configured to display a virtual keypad for receiving payment data such as a PIN of a debit card or the billing postal (zip) code of a credit card, for instance. Display 56 may also be used in this case to receive a selection from the customer regarding the displayed information.

Audio/video electronics 58 are adapted to interface with the CRIND module 40 and/or an auxiliary audio/video source to provide advertising, merchandising, and multimedia presentations to a customer in addition to basic transaction functions. The graphical user interface provided by the dispenser may allow customers to purchase goods and services other than fuel at the dispenser. For example, the customer may purchase a car wash and/or order food from the store while fueling a vehicle.

Referring again to FIG. 1, POS 12 includes a server 58 having a processor 60 and associated memory 61. In the present example, processor 60 executes several software modules including manager workstation module 62 and cashier workstation module 64. When executed, manager workstation module 62 displays a GUI on manager workstation 66 that allows the owner, operator, or manager of the fueling station to set options for the fueling environment. Manager workstation module 66 is also adapted to provide point-of-sale (“POS”) capabilities, including the ability to conduct transactions for items offered for sale by the fueling station. Toward this end, manager workstation 66 includes a suitable display 68, such as a touchscreen display, and may further include one or more speakers 70. As one skilled in art will appreciate, server 58 and manager workstation 66 may be incorporated into the same hardware.

Similarly, cashier workstation module 64 provides the station's cashier, clerk, or employee the means necessary to effect a transaction for one or more items or services offered by the fueling station. Cashier workstation module 64 communicates with the hardware of cashier workstation 72, which includes its own display 74 and optional speaker(s) 76.

In operation, a user positions a vehicle adjacent to one of dispensers 10 and uses the dispenser to refuel the vehicle. For payment, the user inserts and removes a payment card from card reader 52. Card reader 52 reads the information on the payment card and transmits the information to forecourt module 20 via card reader module 26. The forecourt module 20 provides the payment information to network payment module 22, which contacts host processing system 16 operated by the financial institution associated with the user's payment card. The financial institution either validates or denies the transaction and transmits such a response to network payment module 22. The information received from the financial institution's host computer system is transmitted from network payment module 22 back to forecourt module 20 to handle appropriately. This may include transmitting to dispenser 10 a request that the user provide another payment card if the transaction is denied, or printing a receipt if authorized.

For additional information regarding retail fueling environments, reference is made to U.S. Pat. No. 6,435,204 (entitled “Fuel Dispensing System”), U.S. Pat. No. 5,956,259 (entitled “Intelligent Fueling”), U.S. Pat. No. 5,734,851 (entitled “Multimedia Video/Graphics in Fuel Dispensers”), U.S. Pat. No. 6,052,629 (entitled “Internet Capable Browser Dispenser Architecture”), U.S. Pat. No. 5,689,071 (entitled “Wide Range, High Accuracy Flow Meter”), and U.S. Pat. No. 6,935,191 (“entitled “Fuel Dispenser Fuel Flow Meter Device, System and Method”), all of which are hereby incorporated by reference for all purposes as if set forth verbatim herein.

As noted above, it is necessary or desirable to provide remote support capability for POS 12. In this regard, POS 12 includes a modem 78 (or other communication portal) that allows communication with a remote support service 80 via a suitable communication link 82. When remote access is desired, store personnel utilizing POS 12 (e.g., using manager workstation 66) will enable modem 78 so that it will “answer the phone.” If the remote support service provides the correct password as supplied to the remote service agent by the store personnel, remote access will be permitted.

According to the present invention, various password options are provided to enhance the security of remote access. Unlike the prior art, the passwords are generated on an as needed basis, preferably via a seed 84 from a cryptographically secure source. As a result, the passwords are substantially random (i.e., they will not be generated in any sort of predictable fashion). In addition, the passwords will preferably have a specified minimum length. As will be explained, POS 12 may be configured to present either an alphanumeric or a numeric password as selected by the user. The use of symbols as part of an alphanumeric password may also be permitted.

Toward this end, FIG. 4 illustrates an exemplary methodology in accordance with the present invention. The process begins at step 90 when the store personnel utilizing manager workstation 66 initiates a remote support application at POS 12. In accordance with some embodiments, the remote support application may utilize the Remote Access Service (RAS) functionality included in some versions of the Windows operating system. As a result, the modem will be enabled to “answer the phone” (step 92). Next, the remote service application generates a random password of sufficient “strength” to meet a desired level of security (step 94). Typically, the default selection may be an alphanumeric password (with or without symbols), which is then provided to the store personnel, e.g., displayed for the store personnel to see (step 96). The store personnel can then provide the password to the remote service agent (e.g., by reading it over the phone) to gain authorized remote access to POS 12. In particular, the remote support service provides the password back to POS 12 over communications link 82. If the password is verified by processor 60, remote access is allowed.

In some cases, the remote service agent may have difficulty understanding the password as provided verbally by the store personnel. Moreover, in cases where symbols are used, people may not know the name of all of the possible symbols. In this regard, preferred embodiments of the present invention allow the presentation of the password as a phonetic phrase. This is preferably accomplished by the store personnel selecting a function on the user interface of the manager workstation (decision point 98). If the phonetic password option is selected, the phonetic password is displayed (step 100).

In addition, as noted above, preferred embodiments of the present invention allow selection of a numeric password (i.e., all numbers) if desired (decision point 102) which is then displayed (step 104). At any point after generation of the initial password, the store personnel may elect to create a new password (decision point 106), which may be alphanumeric or numeric.

Preferably, any password that is displayed will cease to be displayed after a designated time-out period (decision point 108) or when the store personnel disables remote access (decision point 110), whichever occurs first. As indicated at 112, the password is no longer valid and the process ends.

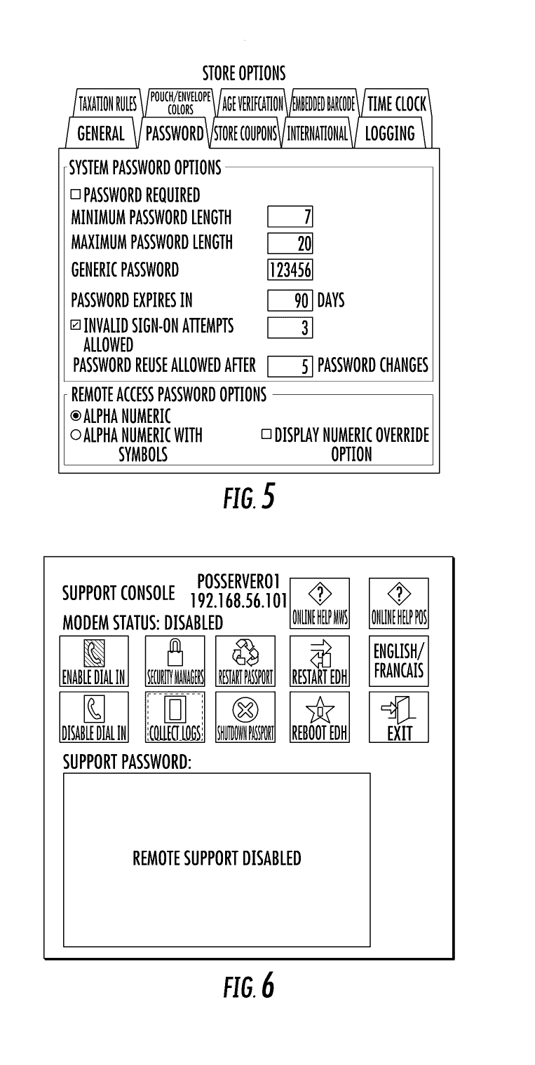

FIGS. 5-9 show various screen displays that can be used in POS 12 in accordance with an embodiment of the present invention. In this regard, FIG. 5 shows a password options tab that may be used in a “Store Options” menu of POS 12 to allow selection of various password parameters. For example, in the “Remote Access Password Options” section, it can be seen that the option of selecting either an “alphanumeric” password or an “alphanumeric with symbols” password is provided. If a numeric override option is desired, this can also be selected.

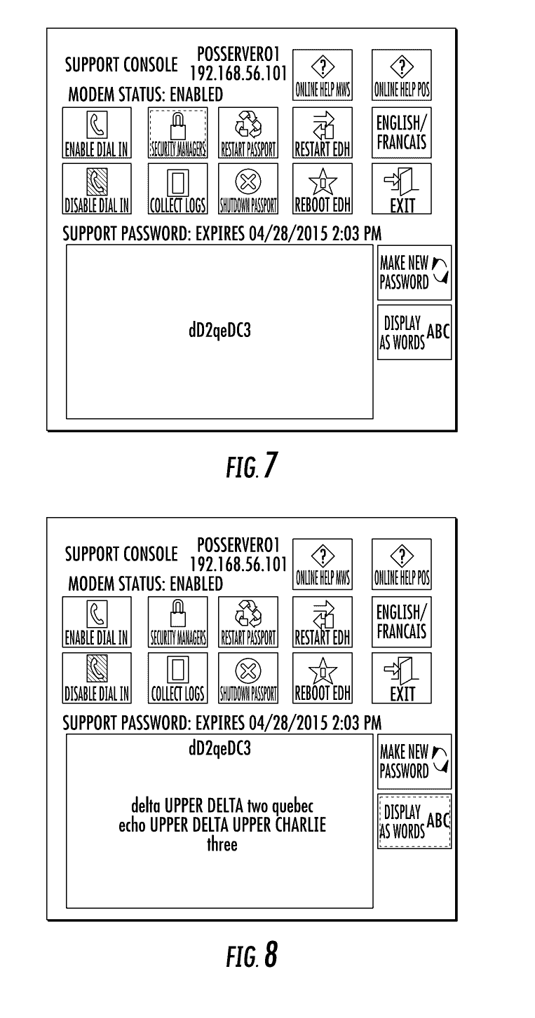

FIG. 6 shows the “Support Console” display that allows the store personnel to initiate the remote support process. As can be seen, the “enable dial in” button is active, thus allowing it to be selected. Once selected, it will enable the modem to “answer the phone” as described above.

In FIG. 7, the store personnel has previously selected “enable dial in,” which causes the “disable dial in” button to become active. In addition, an alphanumeric password “dD2qeDC3,” without symbols in this case, is prominently displayed. If the “display as words” button is then selected, the phonetic equivalent in words will also appear—“delta UPPER DELTA two quebec echo UPPER DELTA UPPER CHARLIE three”—as shown in FIG. 8. The store personnel can read this phrase to the remote service agent to reduce pronunciation errors that might otherwise occur if only the password is read. A new password can be generated at any time by selecting the “make new password” button.

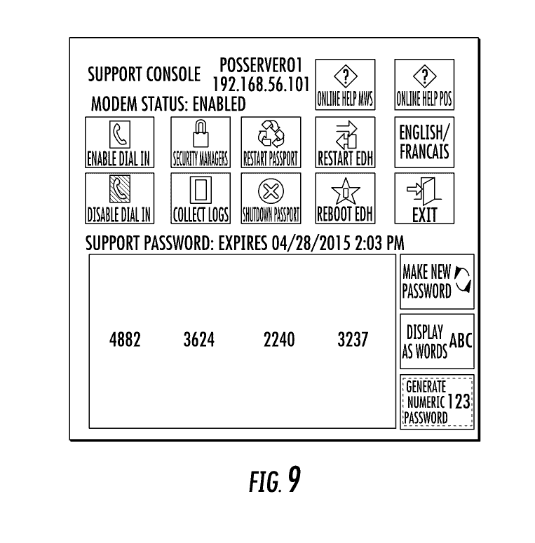

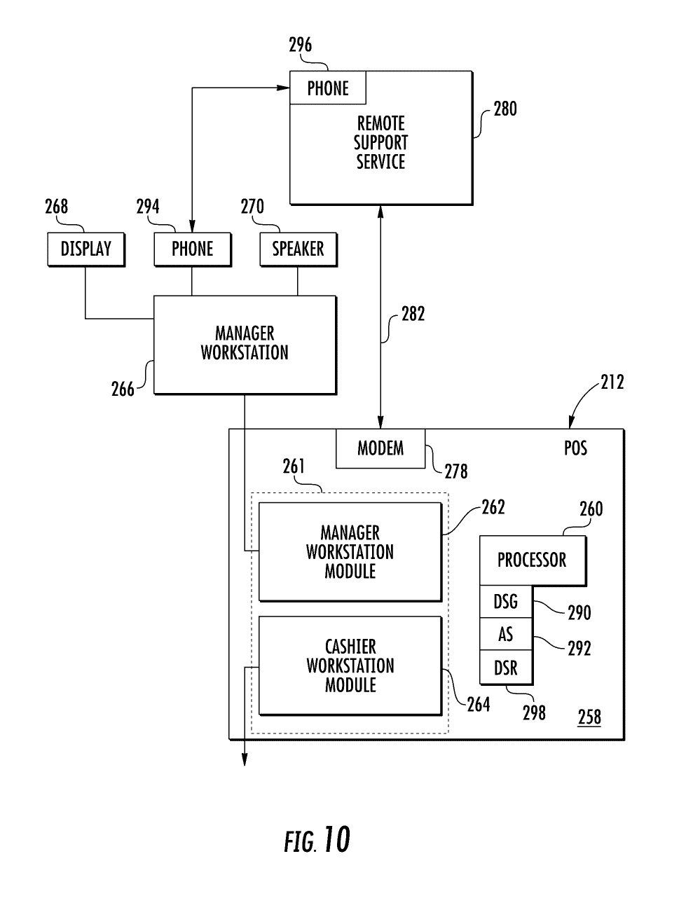

FIG. 9 illustrates an embodiment in which the option to allow numeric passwords has been selected. By selecting the button “generate numeric password,” a numeric password, such as “4882 3624 2240 3237,” will be generated.

The following table shows exemplary phonetic terms that may be used for each letter, number, and symbol that might appear in a remote access password generated by POS 12:

| | Phonetic | | Phonetic | | |
|---|---|---|---|---|---|
| Letter | letter | Number | number | Symbol | Phonetic symbol |
| A | Alpha | 0 | Zero | = | Equals |
| B | Bravo | 1 | One | ? | Question |
| C | Charlie | 2 | Two | + | Plus |
| D | Delta | 3 | Three | * | Star |
| E | Echo | 4 | Four | ~ | Tilde |
| F | Foxtrot | 5 | Five | , | Comma |
| G | Golf | 6 | Six | ; | Semicolon |
| H | Hotel | 7 | Seven | : | Colon |
| I | India | 8 | Eight | - | Dash |
| J | Juliet | 9 | Nine | ! | Exclamation |
| K | Kilo | | | @ | At |
| L | Lima | | | # | Pound |
| M | Mike | | | $ | Dollar |
| N | November | | | % | percent |
| O | Oscar | | | \hat{ } | Caret |
| P | Papa | | | & | And |
| Q | Quebec | | | . | Dot |
| R | Romeo | | | / | Slash |
| S | Sierra | | | | |
| T | Tango | | | | |
| U | Uniform | | | | |
| V | Victor | | | | |
| W | Whiskey | | | | |
| X | X-ray | | | | |
| Y | Yankee | | | | |
| Z | Zulu | | | | |

While the embodiment described above describes a visual password which is read to the remote service agent, various alternatives are also contemplated. For example, the POS may be configured to generate an audible sound that contains a digital signature. This sound can be provided to the remote support agent, for example, over the telephone. In one embodiment, the store personnel can simply hold the phone's handset near the speaker of manager workstation to send the digital signature to the remote support agent. At the remote support service center, the digital signature can be extracted from the sound and provided back to the POS for remote access.

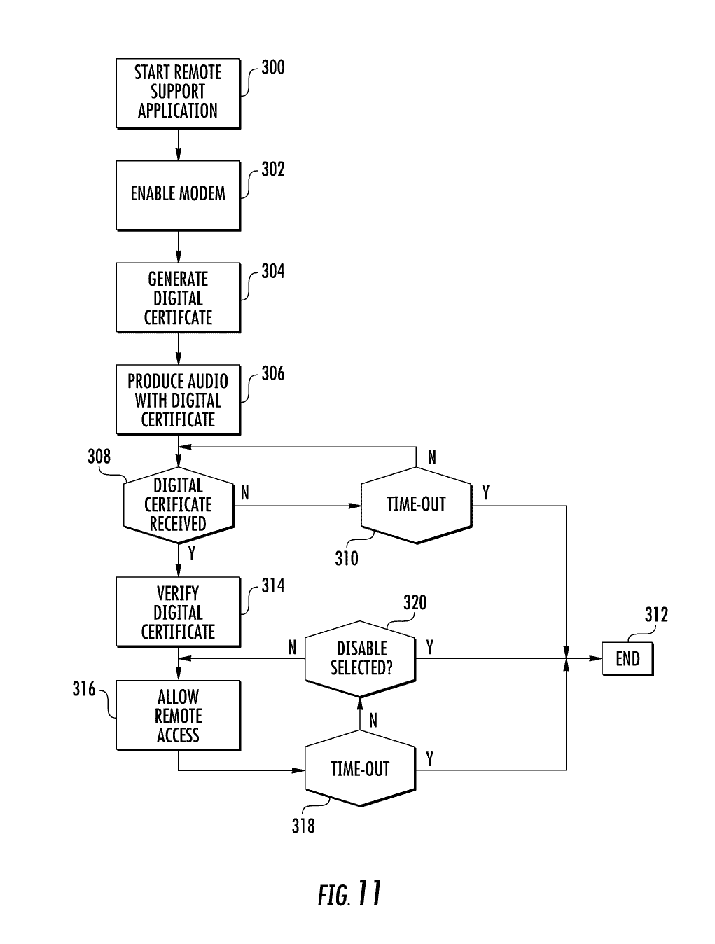

Such an embodiment is illustrated in FIG. 10, where elements analogous to those shown in FIG. 1 have a corresponding reference number augmented by two hundred. Thus, POS system 212 comprises a server 258 having a processor 260 and memory 261. A digital signature generator (“DSG”) 290 is provided to produce a digital signature when needed to allow remote support. The digital signature is then included in audio produced by an audio synthesizer 292 which can be provided into the handset of phone 294 via speaker 270. The sound is received at phone 296 of remote support service 280, whereupon the digital certificate is extracted. The digital certificate can then be provided back to POS 212 via communication link 282, where remote access is allowed if it is electronically recognized by digital certificate recognizer 298.

Toward this end, FIG. 11 illustrates an exemplary methodology that may be performed by POS 212. The process begins at step 300 when the store personnel utilizing manager workstation 266 initiates a remote support application. As a result, the modem will be enabled to “answer the phone” (step 302). Next, the remote service application generates a digital certificate (step 304), and produces audio including the digital certificate (step 306). The store personnel can then provide the audio including the digital certificate to the remote support service (e.g., over the phone). POS 212 waits for the digital certificate to be sent back by the remote support service (decision point 308). If not received back within a designated time period (decision point 310), the process ends (step 312).

If the digital certificate is received and verified (step 314), remote access is allowed (step 316). Preferably, remote access may be disallowed after a designated period of no activity (decision point 318) or when the store personnel disables remote access (decision point 320), whichever occurs first. The process then ends (step 312).

Moreover, teachings of the present invention are not limited to POS 12 or 212, but may also be applied to other components in the retail fueling environment for which remote support might be desired. For example, remote access to EDH 14 or CRIND 40 may be provided in a similar manner. Moreover, in some cases, it may be desirable to have bidirectional passwords (or digital certificates) at the retail fueling environment component and the remote support service center. Password (or digital certificate) validation would thus need to occur on both ends before communication is allowed.

While one or more preferred embodiments of the invention have been described above, it should be understood that any and all equivalent realizations of the present invention are included within the scope and spirit thereof. While much of the discussion above has involved fuel as the exemplary product being dispensed, one skilled in the art will recognize that aspects of the present invention are applicable to a wide variety of different goods and services. Thus, the embodiments depicted are presented by way of example only and are not intended as limitations upon the present invention. For example, many aspects of the present invention are described above in the exemplary context of a retail fueling environment. It should be understood by those of ordinary skill in this art, however, that the present invention is not limited to these embodiments because other commercial environments are contemplated and modifications can be made. Therefore, it is contemplated that any and all such embodiments are included in the present invention as may fall within the scope and spirit thereof.

What is claimed is:

1. An electronic apparatus for use in a retail fueling environment, said apparatus comprising:
a processor and associated memory;
a display;
a communication portal operative to communicate with a remote support service when desired; and
said processor implementing software producing a substantially random credential generated on as needed basis, said processor thereafter receiving via the communication portal a credential electronically presented by the remote support service and allowing access to the electronic apparatus by the remote support service only when the presented credential is the same as the substantially random credential generated on as needed basis.

2. An electronic apparatus as set forth in claim 1, wherein the credential is a password shown on the display.

3. An electronic apparatus as set forth in claim 2, wherein the password is an alphanumeric password.

4. An electronic apparatus as set forth in claim 2, wherein the password is an alphanumeric password with symbols.

5. An electronic apparatus as set forth in claim 1, wherein the credential is a password and said processor is further operative to display a phonetic phrase corresponding to the password.

6. An electronic apparatus as set forth in claim 5, wherein said password and said phonetic phrase corresponding to the password are simultaneously displayed.

7. An electronic apparatus as set forth in claim 1, wherein said electronic apparatus comprises a point-of-sale (POS) system.

8. An electronic apparatus as set forth in claim 7, wherein said POS system comprises a manager workstation and at least one cashier workstation.

9. An electronic apparatus as set forth in claim 1, wherein said credential is generated via a seed from a cryptographically secure source.

10. An electronic apparatus as set forth in claim 9, wherein said credential times out after a predetermined period of time unless earlier disabled by a user.

11. An electronic apparatus as set forth in claim 1, wherein said credential can be any one of an alphanumeric password, an alphanumeric password with symbols, and a numeric password.
